(19) United States
(12) Patent Application Publication
(10) Pub. No.: US 2024/0291305 A1
(43) Pub. Date: Aug. 29, 2024

(54) SMART SUPERCAPACITOR JUMP STARTER CAPABLE OF AUTOMATIC BOOST CHARGE

(71) Applicant: SHENZHEN KEENPOWER TECHNOLOGY CO., LTD., SHENZHEN (CN)

(72) Inventor: JINGLUAN LV, FUZHOU (CN)

(21) Appl. No.: 18/433,586

(22) Filed: Feb. 6, 2024

(30) Foreign Application Priority Data
Feb. 24, 2023 (CN) 202320308876.7

(51) Int. Cl. H02J 7/00; H02J 1/10; H02J 7/34

(52) U.S. Cl. CPC H02J 7/0068; H02J 1/122; H02J 7/0042; H02J 7/342; H02J 7/345; H02J 2207/30

(57) ABSTRACT

The present disclosure relates to a smart supercapacitor jump starter capable of automatic boost charge, which belongs to the technical field of car power supplies. The jump starter includes a housing, where a supercapacitor module, a main control board, a boost/buck module, a charging relay and a discharging relay that are electrically connected are arranged in the housing, the charging relay and the discharging relay are connected to a circuit in series and extend out of the housing to be electrically connected to a positive terminal by means of wires, and the supercapacitor module extends out of the housing to be electrically connected to a negative terminal by means of a wire. The positive terminal is connected to a positive electrode of a car power supply, and the negative terminal is connected to a negative electrode of the car power supply.

### TECHNICAL FIELD

The present disclosure relates to a jump starter, and particularly relates to a smart supercapacitor jump starter capable of automatic boost charge, which belongs to the technical field of car power supplies.

### BACKGROUND ART

When failure in ignition and start of a car is caused by breakdown, battery power deficit, battery damage, too low temperature, etc., a jump starter is required to start a car.

The jump starter is a type of portable jump starter integrating power supply and charging functions and can ensure that the car can be started in an emergency at normal temperature environment. According to different battery cells, existing jump starters are divided into different types including lithium batteries, lithium polymer batteries, lead-acid batteries, supercapacitors and so on, among which the lead-acid batteries and the lithium polymer batteries are more common.

Traditionally, the maintenance-free lead-acid storage battery is used as a jump starter. But because the storage battery is aged, undercharged or disused for a long time or the weather is cold, power supply to the storage battery is insufficient, and a generator cannot be started normally. Moreover, during high-temperature storage, a battery cell will bulge, leaks a liquid and even produces smoke, ignites and explodes. The lithium battery jump starter is small in current and costly, despite light weight and compact size, and is likely to explode, burn and so on. The two power supplies described above both have the problem of self-consumption. They will lose power after being stored for a period of time, and will be unusable in an emergency if not charged in time.

Therefore, there is an urgent need for a novel jump starter to overcome the defects in the prior art.

### SUMMARY

In view of this, the present disclosure provides a smart supercapacitor jump starter capable of automatic boost charge, which is used for solving the problems of power shortage and difficult startup of a car caused by environment or battery damage in the prior art.

The technical solution of the present disclosure for solving the above technical problems is as follows:

A smart supercapacitor jump starter capable of automatic boost charge includes a housing. A supercapacitor module, a main control board, a boost/buck module, a charging relay and a discharging relay that are electrically connected are arranged in the housing. The charging relay and the discharging relay are connected to a circuit in series and extend out of the housing to be electrically connected to a positive terminal by means of wires. The supercapacitor module extends out of the housing to be electrically connected to a negative terminal by means of a wire.

A display module and a key module are further arranged on the housing. The display module and the key module are electrically connected to the main control board.

The positive terminal is connected to a positive electrode of a car power supply. The negative terminal is connected to a negative electrode of the car power supply.

On the basis of the above technical solution, the present disclosure can also be improved as follows:

Further, the supercapacitor module is formed by 6 supercapacitors connected in series.

Further, the housing further includes a temperature measurement module. The temperature measurement module is electrically connected to the main control board and the supercapacitor module.

Further, a type-c input port and a universal serial bus (USB) output port are provided on the housing and electrically connected to the main control board by means of a type-c input module and a USB output module respectively.

Further, the display module is a liquid crystal display screen.

Beneficial effects of the present disclosure are as follows:
(1) The supercapacitor features wide operating temperature limit, no maintenance and long cycle life. The supercapacitor module can be charged at high power in boost and buck modes, and charging power reaches 160 W. It takes only 2 minutes to achieve full charge 15V from low charge 12 V, such that charging is faster than charging other jump starters. A charging input voltage range is wider, and charging can be normally carried out from 5 V to 15 V, such that a residual capacity of a car battery is effectively used.
(2) Charging can be carried out by a household charger, a mobile power supply, a car battery, etc. No chemical reaction or electrochemical reaction occurs. An electrode material and electrolyte are relatively stable, such that storage safety is high, and explosion and ignition are less likely to occur. A number of times of cycle is higher and can reach 50 W. A low-temperature effect is desirable, and normal operation can be carried out in an environment having a lowest temperature of −40° C. Internal resistance is lower than that of a lithium polymer.
(3) The present disclosure is suitable for starting a gasoline vehicle having a 12 V power supply system, and a diesel vehicle having a 12 V power supply system. The jump starter is light in whole, convenient to use for car rescue, convenient to carry, easy to operate, fast to charge, safe and stable to store, and has functions of a common jump starter.

### BRIEF DESCRIPTION OF THE DRAWINGS

FIG. 1 is a modular schematic diagram of a structure according to the present disclosure.

### DETAILED DESCRIPTION OF THE EMBODIMENTS

The principles and features of the present disclosure will be described below in combination with accompanying drawings. The illustrated instances are only intended to illustrate the present disclosure but are not intended to limit the scope of the present disclosure.

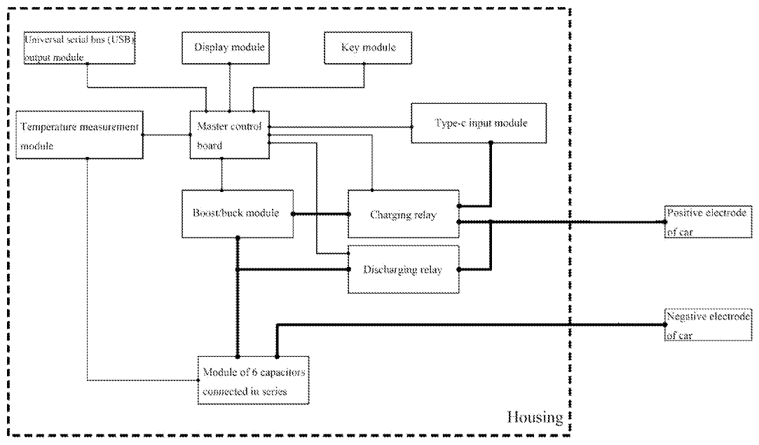

As shown in FIG. 1, a smart supercapacitor jump starter capable of automatic boost charge includes a housing. A supercapacitor module, a main control board, a boost/buck module, a charging relay and a discharging relay that are electrically connected are arranged in the housing. The charging relay and the discharging relay are connected to a circuit in series and extend out of the housing to be electrically connected to a positive terminal by means of wires. The supercapacitor module extends out of the housing to be electrically connected to a negative terminal by means of a wire.

A display module and a key module are further arranged on the housing. The display module and the key module are electrically connected to the main control board.

The positive terminal is connected to a positive electrode of a car power supply. The negative terminal is connected to a negative electrode of the car power supply.

In another embodiment of the present disclosure, the supercapacitor module is formed by 6 supercapacitors connected in series.

In another embodiment of the present disclosure, the housing further includes a temperature measurement module. The temperature measurement module is electrically connected to the main control board and the supercapacitor module.

In another embodiment of the present disclosure, a type-c input port and a universal serial bus (USB) output port are provided on the housing and electrically connected to the main control board by means of a type-c input module and a USB output module respectively.

In another embodiment of the present disclosure, the display module is a liquid crystal display screen.

A working principle of the present disclosure is as follows: a negative electrode of the supercapacitor module is directly connected to the negative terminal by means of a fastening screw, and a positive electrode of the supercapacitor module is connected to the positive terminal by connecting a discharging relay in series.

When the positive terminal is clamped to the positive electrode of the car and the negative terminal is clamped to the negative electrode of the car, the main control board will determine whether the car battery has power left or not and a current voltage is displayed. A boost/buck charging circuit is connected by a charging/discharging relay connected to the positive terminal. An output end of the charging circuit is directly connected to the positive electrode of the supercapacitor module. When a voltage of the car battery is higher than that of the supercapacitor module, the charging circuit boost-charges the supercapacitor module. When the voltage of the car battery is lower than a voltage of the supercapacitor module, the charging circuit buck-charges the supercapacitor module.

The above examples are merely preferred examples of the present disclosure but not intended to limit the present disclosure. Any modification, equivalent substitution, improvement, etc. made within the spirit and principles of the present disclosure should all fall within the scope of protection of the present disclosure.

What is claimed is:

1. A smart supercapacitor jump starter capable of automatic boost charge, comprising a housing, wherein a supercapacitor module, a main control board, a boost/buck module, a charging relay and a discharging relay that are electrically connected are arranged in the housing, the charging relay and the discharging relay are connected to a circuit in series and extend out of the housing to be electrically connected to a positive terminal by means of wires, and the supercapacitor module extends out of the housing to be electrically connected to a negative terminal by means of a wire;
a display module and a key module are further arranged on the housing, and the display module and the key module are electrically connected to the main control board; and
the positive terminal is connected to a positive electrode of a car power supply, and the negative terminal is connected to a negative electrode of the car power supply.

2. The smart supercapacitor jump starter capable of automatic boost charge according to claim 1, wherein the supercapacitor module is formed by 6 supercapacitors connected in series.

3. The smart supercapacitor jump starter capable of automatic boost charge according to claim 1, wherein the housing further comprises a temperature measurement module, and the temperature measurement module is electrically connected to the main control board and the supercapacitor module.

4. The smart supercapacitor jump starter capable of automatic boost charge according to claim 1, wherein a type-c input port and a universal serial bus (USB) output port are provided on the housing and electrically connected to the main control board by means of a type-c input module and a USB output module respectively.

5. The smart supercapacitor jump starter capable of automatic boost charge according to claim 1, wherein the display module is a liquid crystal display screen.
